(19) United States
(12) Patent Application Publication
(10) Pub. No.: US 2002/0097291 A1
(43) Pub. Date: Jul. 25, 2002

(54) Establishing and maintaining registration of an image forming system in the slow-scan axis

(75) Inventors: Vittorio Castelli, Yorktown Heights, NY (US); Joannes N.M. deJong, Suffern, NY (US); Lloyd A. Williams, Mahopac, NY (US); Harold M. Anderson, Rancho Palo Verdes, CA (US)

Correspondence Address: LAHIVE & COCKFIELD, 28 STATE STREET, BOSTON, MA, 02109, US

(73) Assignee: Xerox Corporation

(21) Appl. No.: 09/768,681

(22) Filed: Jan. 24, 2001

(51) Int. Cl. B41J 29/393

(52) U.S. Cl. 347/19

(57) ABSTRACT

A variety of encoder wheels and encoder wheel sensors are provided to provide precise paper locating capability relative to a printing device in an image forming system.

### FIELD OF THE INVENTION

The present invention relates generally to the positioning of printing surfaces and printing devices and specifically to the calibration of a printing device in the slow-scan axis relative to a piece of paper.

### BACKGROUND OF THE INVENTION

Multi-scan printing involves the use of a printing device smaller than the printed image by the use of multiple swaths. The printing device is moved with respect to a piece of paper between printing each swath. Multi-scan printing provides many benefits, including low cost from the use of smaller printing devices and the ability to fully imprint large pieces of paper.

One difficulty in multi-scan printing involves the above-mentioned relocating of the printing device with respect to the piece of paper from one printing swath to the next, also called “stitching.” Stitching accuracy must be high for the printed image not to contain undesirable visible artifacts. Similarly, the use of multiple printing devices to obtain a multi-color printed image also requires the alignment of one printing device to another to avoid visible artifacts.

One approach to the difficulties of multi-scan printing has been the use of small printing devices to produce narrow swaths. By the use of narrow swaths, it is possible to move the printing device relative to the piece of paper only a small distance by the rotation of a wheel, preferably a small amount of rotation of the wheel per swath. Swath widths in this type of multi-scan printing are typically less than one centimeter. One drawback of this approach is a reduction of printing efficiency by requiring many swaths to print an image.

A more efficient approach to multi-scan printing does involve the use of larger printing devices, such as printing devices capable of printing a swath of over 1 cm wide. Multi-scan printing involving wider swaths provides a substantial benefit in increasing the speed of printing. However, one difficulty of this type of multi-scan printing involves positioning the printing device relative to the paper in order to provide high accuracy in stitching. One approach has been to use high accuracy encoders to establish a location of the printing device relative to the paper. High costs of such precise encoders has proven to be prohibitive in some applications.

Furthermore, calibration of such encoders can be difficult. For example, while factory calibration procedures may initially calibrate the encoders, by the time a printing device is put in service in the field, the encoders may be out of alignment, thereby unable to provide accurate positioning information and hence resulting in poor stitching. Even if calibration can be maintained up to the time of initial use of the printing device, during use, a printing device may experience a change in alignment characteristics due to component wear or even due to changes of temperatures of various components involved with positioning the printing device relative to the piece of paper. Furthermore, a printing device will likely eventually require replacement. In any event, requiring the return of a printing device to the factory for calibration or replacement is undesirable.

### SUMMARY OF THE INVENTION

The present invention recognizes a need in the art to provide the ability to precisely locate a printing device relative to a piece of paper while avoiding a need for expensive encoders. The present invention overcomes the difficulties of the prior art by the use of an optical sensor, preferably mounted to a printing device. The optical sensor is adapted to monitor marks on a piece of paper or on a paper handling surface configured to move the piece of paper.

According to an embodiment of the invention, a distance measuring apparatus measuring paper movement within an image forming system is provided having a first encoder wheel adapted to be rotatably mounted to the image forming system and oriented to be able to contact a piece of paper along a portion of a circumference of the encoder wheel, a first encoder sensor adapted to be mounted to the image forming system and located proximate to the first encoder wheel and capable of detecting a rotational position of the first encoder wheel, a second encoder wheel adapted to be rotatably mounted to the image forming system, coaxial to the first encoder wheel and independently rotatable to the first encoder wheel and oriented to be able to contact the piece of paper along a portion of a circumference of the encoder wheel and a second encoder sensor adapted to be mounted to the image forming system and located proximate to the second encoder wheel and capable of detecting a rotational position of the second encoder wheel.

According to a further embodiment of the invention, a method for moving paper within an image forming system is provided, having the steps of providing a first encoder wheel adapted to rotate in conjunction with the paper within the image forming system, monitoring a rotational position of the first encoder wheel by the use of a first encoder sensor located proximate to the first encoder wheel, providing a second encoder wheel adapted to rotate in conjunction with the paper within the image forming system, coaxial to the first encoder wheel and independently rotatable to the first encoder wheel, monitoring a rotational position of the second encoder wheel by the use of a second encoder sensor located proximate to the first encoder wheel and driving the first encoder wheel and the second encoder wheel such that the paper travels in a predetermined direction within the image forming system.

### BRIEF DESCRIPTION OF THE DRAWINGS

The foregoing and other objects, features and advantages of the invention will be apparent from the following description and apparent from the accompanying drawings, in which like reference characters refer to the same parts throughout the different views. The drawings illustrate principles of the invention and, although not to scale, show relative dimensions.

FIG. 1 is a top view of an image forming system according to an embodiment of the present invention;

FIG. 2 is a diagram of a sinusoidal encoder wheel according to the present invention;

FIG. 3 is a graph of a sample output of the embodiment of FIG. 2;

FIG. 4 is a diagram of saw tooth encoder wheel according to the present invention;

FIG. 5 is a diagram of a binary encoder wheel according to the present invention;

FIG. 6 is a graph of a sample output of the binary encoder wheel of the present invention shown in FIG. 5; and

FIG. 7 is a diagram of a flag encoder wheel according to the present invention.

### DETAILED DESCRIPTION OF THE INVENTION

The present invention, in various embodiments, involves the use of encoder wheels to provide detailed information regarding paper location. The term “image forming system” includes a collection of different printing technologies, such as electrophotographic, electrostatic, electrostatographic, ionographic, acoustic, piezo, thermal, laser, ink jet, and other types of image forming or reproducing systems adapted to capture and/or store image data associated with a particular object, such as a document, and reproduce, form, or produce an image. An example of an image forming system can be found in U.S. Pat. No. 5,583,629 to Brewington et al., the contents of which are herein incorporated by reference. As used herein, the term “paper” is intended to include a wide variety of imprintable media.

Encoder wheels are used within image forming systems in order to accurately position a piece of paper within the image forming system. As discussed above, accurate positioning is important to properly locate a printed image on the paper. Although all image forming systems benefit from accurate image location, multi-scan printing technology is particularly dependent on proper image location because stitching accuracy must be high for the printed image not to contain undesirable visible artifacts. Preferably, encoder wheels will also be drive wheels, capable of moving the paper through the image forming system. Ideally, two independently-driven encoder wheels will be provided to move the paper.

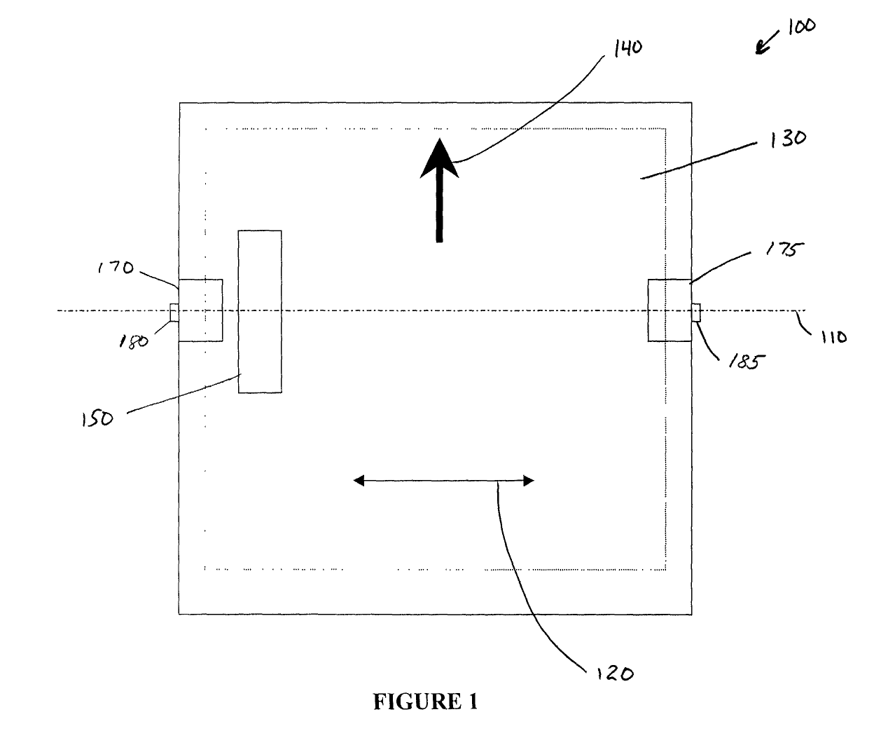

The encoder wheels of the present invention may be provided in an image forming system 100, as shown in FIG. 1. By way of example, an image forming system 100 is shown having two independently driven pinch wheels, such as, for example, a first encoder wheel 170 and a second encoder wheel 175, located along an axis 110 and laterally disposed with respect to each other in a fast scan direction signified by arrow 120.

A piece of paper 130 is shown having a direction of travel indicated by arrow 140. A first encoder sensor 180 and a second encoder sensor 185 are further provided proximate to the first encoder wheel 170 and the second encoder wheel 175, respectively, to determine the rotational position of the corresponding sinusoidal encoder wheel 170, 175. Preferably, a printing device 150 is provided to slide in the fast scan direction signified by arrow 140 to enable printing of the paper 130. Alternatively, other types of forming an image may be used that do not involve such movement of a printing device 150. In operation, the image forming system 100 monitors the rotational position of each of the first encoder wheel 170 and the second encoder wheel 175 to move the paper 130 along the desired direction of travel, such as that indicated by arrow 140. The image forming system 100 may include a controller to facilitate monitoring the rotational position of each of the first encoder wheel 170 and the second encoder wheel 175 by being coupled to an output of each of the first encoder sensor 180 and the second encoder sensor 185. The controller may be a microprocessor or other device capable of processing input signals and controlling the motion of the encoder wheels. An example of a controller can be found in U.S. Pat. No. 4,478,509 to Daughton et al., the contents of which are herein incorporated by reference.

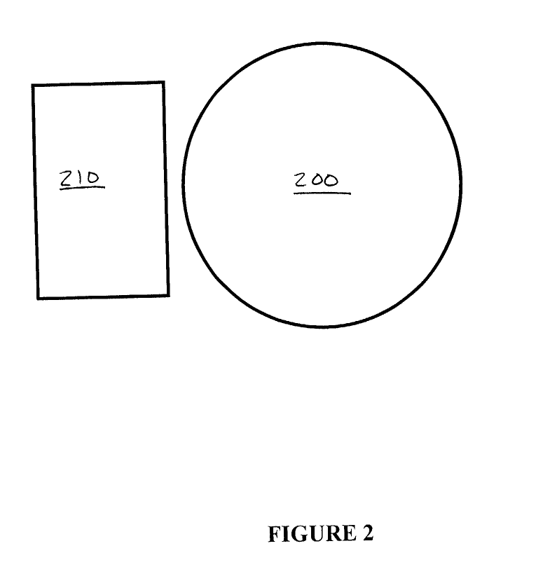

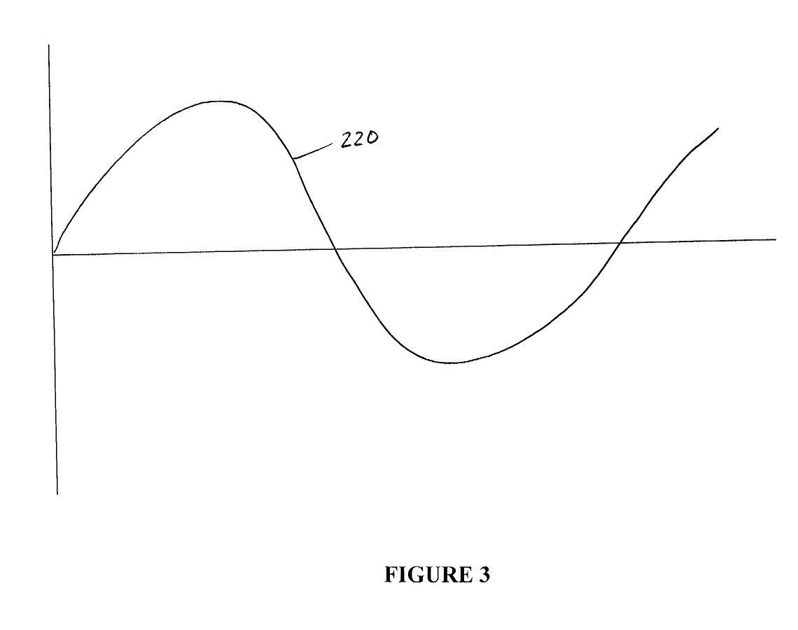

According to an embodiment of the invention, a sinusoidal encoder wheel 200 is provided as shown in FIG. 2. The sinusoidal encoder wheel 200 operates by the use of magnetic or electrical fields generated between the sinusoidal encoder wheel 200 and sinusoidal encoder sensor 210. A sample output 220 from the sinusoidal encoder wheel 200 is shown in FIG. 3. The output can be sinusoidal in electrical potential, e.g. voltage or in electrical resistance, e.g. ohms. A benefit of use of the sinusoidal encoder wheel 200 is that angular position data is provided regardless of the angular position of the sinusoidal encoder wheel 200.

The diameters of the independently driven pinch wheels are chosen so that the length of the printed swath is an integer multiple, preferably one, of the circumferences of the independently driven pinch wheels. Having such an integer multiple of one is called “synchronism” and mitigates the effects of wheel eccentricity errors. Non-synchronous paper advances can also be controlled by the construction of correlation tables for sequences of moves which must always start at the same wheel position. Therefore, in a non-synchronous system, the independently driven pinch wheels must be brought back to a specific starting rotational position at the beginning of each sheet of paper.

Even when diameters of the pinch wheels are selected to be an integer multiple of the swath widths, the circumference of the wheel may not match the desired amount of paper advance. For example, for an acoustic inkjet image forming system, it may be desirable to first print half pixels, leaving spaces between the half pixels, and then subsequently print the other half pixels. After the first half pixels are printed, any of several different means may be employed to move either the printing device 150 or the paper 130 so that the same printing device can properly place the printing of the remaining half pixels. For example, a paper advancement of 1/1200ths of an inch is typical. Inaccuracy in this paper advancement distance will adversely affect optical density and registration of the printed image.

The encoder wheels and encoder sensors of the present invention are preferably able to provide precise paper advancement to at least 1/1200ths of an inch, thereby providing accurate relative placement of the paper and a printing device.

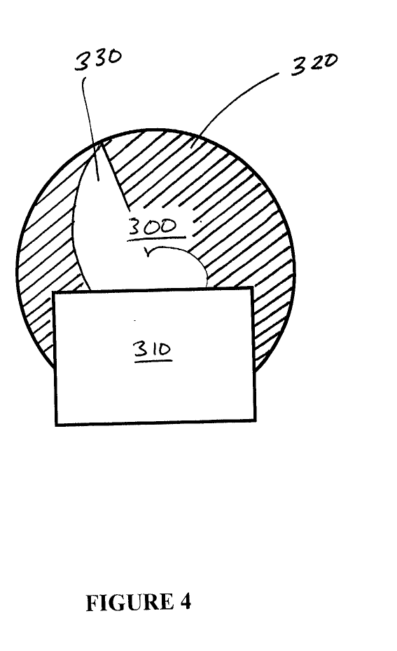

According to a further variation of the present invention, a saw tooth encoder wheel 300 is provided as shown in FIG. 4, along with a saw tooth encoder sensor 310. Preferably, the saw tooth encoder wheel 300 involves the optical interrelation of a first pattern 320 and a second pattern 330, printed on a face of the saw tooth encoder wheel 300. The saw tooth encoder sensor 310 is located proximate to the saw tooth encoder wheel 300 to provide information based on an angular location of the saw tooth encoder wheel 300. Preferably, an output of the saw tooth encoder sensor 310 is similar to the output 220 of the sinusoidal encoder sensor 210 as shown in FIG. 3. The saw tooth encoder wheel 300 is the preferred embodiment of the present invention. As with the first embodiment of the present invention involving the sinusoidal encoder wheel 200, the saw tooth encoder wheel 300 preferably also provides angular location information for every angular position of the saw tooth encoder wheel 300.

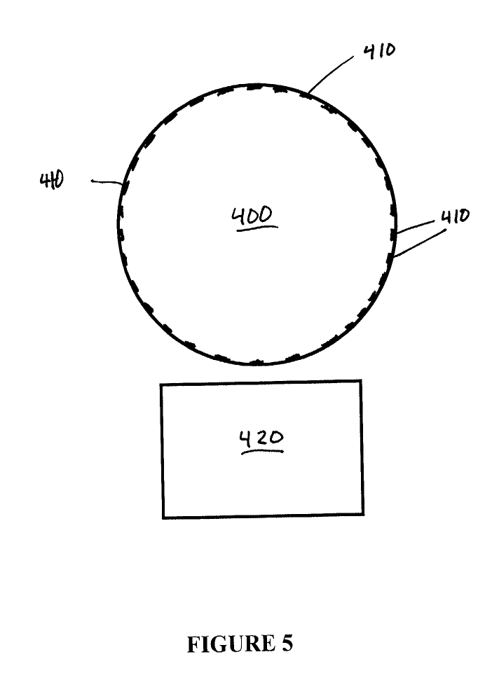

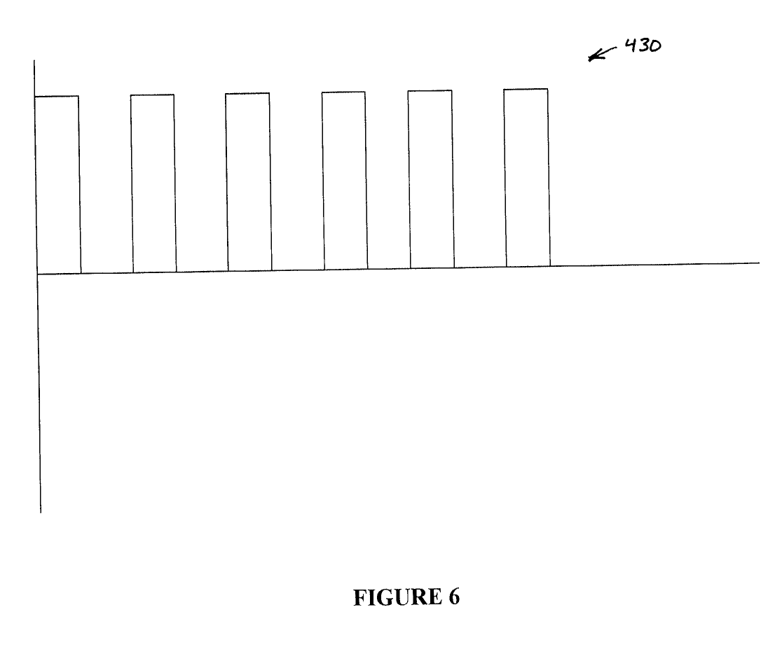

According to a further variation, the invention involves a binary encoder wheel 400 having position identifiers 410 located at a pre-selected interval of angular locations around the circumference of the binary encoder wheel 400, as shown by way of example in FIG. 5. An encoder wheel sensor 420 is also provided to provide a pulse output upon communication with each of the position identifiers 410. Therefore, the binary encoder wheel 400 according to the present variation of the invention does not provide angular position information for every angular position of the binary encoder wheel 400, as no information is available between the position identifiers 410. An output 430 of the binary encoder wheel sensor 420 is provided in FIG. 6.

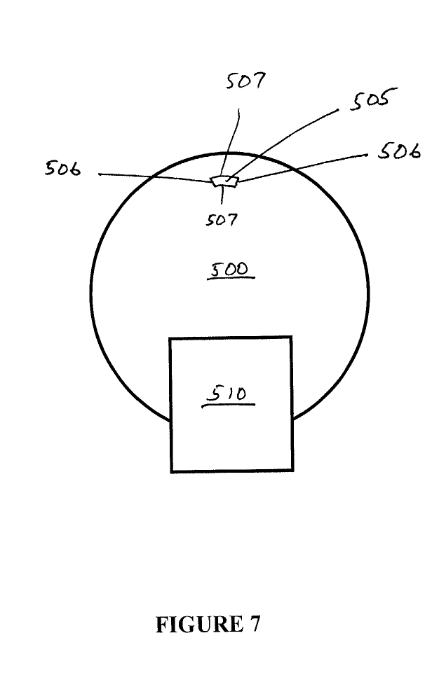

Another variation of the invention, shown in FIG. 7, is a flag encoder wheel 500 in communication with a flag encoder sensor 510. The flag encoder wheel 500 allows precise positioning at each full revolution of the flag encoder wheel 500. Preferably the flag encoder sensor 5 10 is a differential sensor, thereby providing a differential reading of each side of the flag 505 of the flag encoder wheel 500. Upon equalization of the reading from the differential type flag encoder sensor 510, the flag encoder wheel 500 is precisely angularly located. Also within the scope of the invention are other types of flag encoder sensors 5 10, such as edge detection sensors and the like.

Preferably, the flag 505 illustrated in FIG. 6 will be formed having radially positioned edges 506 and coaxially oriented circumferential ends 507. Alternatively, the flag 505 may be rectangular or other shape adapted for use with the flag encoder sensor 510. Preferably, the flag 505 is sized so as to accommodate foreseeable errors in positioning after multiple rotations of the flag encoder wheel 500, to allow precise positioning of the paper after extended paper advances. The flag encoder sensor 510 may also be a single cell detector. The flag 505 may be illuminated and imaged with optics onto a photo detector or may be in the form of a transparent aperture in an opaque disk or, preferably, a reflective mark on an optically absorptive flag encoder wheel 500 surface.

These examples are meant to be illustrative and not limiting. The present invention has been described by way of example, and modifications and variations of the exemplary embodiment will suggest themselves to skilled artisans in this field without departing from the spirit of the invention. Features and characteristics of the above-described embodiments and variations may be used in combination. The preferred embodiments and variations are merely illustrative and should not be considered restrictive in any way. The scope of the invention is to be measured by the appended claims, rather than the preceding description, and all variations and equivalents that fall within the range of the claims are intended to be embraced therein.

Having described the invention, what is claimed as new and protected by Letters Patent is:

1. A distance measuring apparatus measuring paper movement within an image forming system, comprising:
a first encoder wheel adapted to be rotatably mounted to said image forming system and oriented to be able to contact a piece of paper along a portion of a circumference of said encoder wheel;
a first encoder sensor adapted to be mounted to said image forming system and located proximate to said first encoder wheel and capable of detecting a rotational position of said first encoder wheel;
a second encoder wheel adapted to be rotatably mounted to said image forming system, coaxial to said first encoder wheel and independently rotatable to said first encoder wheel and oriented to be able to contact said piece of paper along a portion of a circumference of said encoder wheel; and
a second encoder sensor adapted to be mounted to said image forming system and located proximate to said second encoder wheel and capable of detecting a rotational position of said second encoder wheel.

2. The image forming system of claim 1, further comprising a printing device slidably mounted to said image forming system and adapted to imprint said piece of paper.

3. The distance measuring apparatus of claim 1, wherein said first encoder wheel and said second encoder wheel are each a sinusoidal encoder wheel and said first encoder sensor and said second encoder sensor are each a sinusoidal encoder sensor.

4. The distance measuring apparatus of claim 3, wherein said sinusoidal encoder sensor detects said rotational position of said encoder wheel by detecting a voltage.

5. The distance measuring apparatus of claim 3, wherein said sinusoidal encoder sensor detects said rotational position of said encoder wheel by detecting an electrical resistance.

6. The distance measuring apparatus of claim 1, wherein said first encoder wheel and said second encoder wheel are each a saw tooth encoder wheel and said first encoder sensor and said second encoder sensor are each a saw tooth encoder sensor.

7. The distance measuring apparatus of claim 1, wherein said first encoder wheel and said second encoder wheel are each binary encoder wheel and said first encoder sensor and said second encoder sensor are each a binary encoder sensor.

8. The distance measuring apparatus of claim 1, wherein said first encoder wheel and said second encoder wheel are each flag encoder wheel and said first encoder sensor and said second encoder sensor are each a flag encoder sensor.

9. The distance measuring apparatus of claim 8, wherein said flag encoder sensor is a differential sensor.

10. The distance measuring apparatus of claim 8, wherein said flag encoder sensor is an edge sensor.

11. The distance measuring apparatus of claim 1, wherein said first encoder wheel and said second encoder wheel are independently driven and capable of moving said piece of paper through said image forming system.

12. A method for moving paper within an image forming system, comprising the steps of:
providing a first encoder wheel adapted to rotate in conjunction with said paper within said image forming system;
monitoring a rotational position of said first encoder wheel by the use of a first encoder sensor located proximate to said first encoder wheel;
providing a second encoder wheel adapted to rotate in conjunction with said paper within said image forming system, coaxial to said first encoder wheel and independently rotatable to said first encoder wheel;
monitoring a rotational position of said second encoder wheel by the use of a second encoder sensor located proximate to said first encoder wheel; and
driving said first encoder wheel and said second encoder wheel such that said paper travels in a predetermined direction within said image forming system.
